(19) United States
(12) Patent Application Publication
(10) Pub. No.: US 2024/0332688 A1
(43) Pub. Date: Oct. 3, 2024

(54) HOLDING APPARATUS

(71) Applicant: Honda Motor Co., Ltd., Tokyo (JP)

(72) Inventors: Masanori Shin, Saitama (JP); Hiroyuki Ichikawa, Saitama (JP)

(21) Appl. No.: 18/616,342

(22) Filed: Mar. 26, 2024

(30) Foreign Application Priority Data
Mar. 30, 2023 (JP) 2023-054701

(51) Int. Cl. H01M 50/209; H01M 50/244; H01M 50/271; H01M 50/296

(52) U.S. Cl. CPC H01M 50/209; H01M 50/244; H01M 50/271; H01M 50/296

(57) ABSTRACT

A holding apparatus includes: a holder holding a power storage device to be detachable; and a housing provided to house the holder. The holder is provided such that an attachment and detachment direction in which the power storage device is attached to or detached from the holder is inclined with respect to a direction orthogonal to a placement surface of the housing.

### CROSS-REFERENCE TO RELATED APPLICATION

This application is based upon and claims the benefit of priority from Japanese Patent Application No. 2023-054701 filed on Mar. 30, 2023, the content of which is incorporated herein by reference.

### BACKGROUND OF THE INVENTION

### Field of the Invention

The present invention relates to a repair search system for holding a power storage device to be detachable.

### DESCRIPTION OF THE RELATED ART

### Field of the Invention

The present invention relates to a holding apparatus for holding a power storage device.

### Description of the Related Art

As a device of this type, there is known a device in which a holder having a housing portion to hold a battery is movably provided with respect to a housing. Such a device is described, for example, in International Publication No. 2022/220183 (WO2022/220183A). In the device described in WO2022/220183A, the holder is movably supported by the housing so that the housing portion can be moved between a retracted position in which the battery is retracted and an inclined position in which the battery is attached or detached.

However, in the device described in WO 2022/220183A, the upper surface of the housing is closed, making it difficult to effectively utilize the space above the housing for attaching and detaching the battery.

### SUMMARY OF THE INVENTION

An aspect of the present invention is a holding apparatus including: a holder holding a power storage device to be detachable; and a housing provided to house the holder. The holder is provided such that an attachment and detachment direction in which the power storage device is attached to or detached from the holder is inclined with respect to a direction orthogonal to a placement surface of the housing.

### BRIEF DESCRIPTION OF THE DRAWINGS

The objects, features, and advantages of the present invention will become clearer from the following description of embodiments in relation to the attached drawings, in which:

FIG. 1 is a perspective view schematically illustrating an external appearance shape of a holding apparatus according to an embodiment of the present invention;

FIG. 2 is a front view of the holding apparatus in a state in which a front wall is removed;

FIG. 3 is a cross-sectional view taken along line III-III in FIG. 2;

FIG. 4 is a perspective view illustrating a configuration of the horizontal plate included in the holding apparatus in FIG. 1;

FIG. 5 is a perspective view illustrating an overall configuration of the battery held by the holding apparatus in FIG. 1;

FIG. 6 is a diagram for describing operations and effects of the holding apparatus according to the embodiment of the present invention;

FIG. 7 is a side view illustrating an outer appearance shape of the holding apparatus according to the embodiment of the present invention;

FIG. 8 is a cross-sectional view of an upper part of FIG. 7;

FIG. 9 is a front view of the holding apparatus in a state in which a lid is open; and

FIG. 10 is a perspective view of a upper surface of the case in state in which the lid is removed.

### DETAILED DESCRIPTION OF THE INVENTION

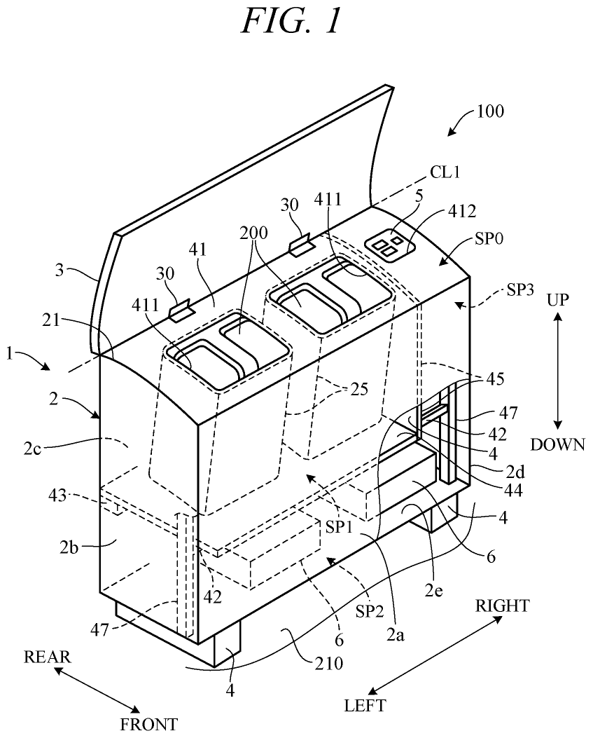

Hereinafter, embodiments of the present invention will be described with reference to FIGS. 1 to 10. A holding apparatus according to an embodiment of the present invention is an apparatus for holding a storage battery (a secondary battery) such as a battery. Such a holding apparatus can be configured as a charging and feeding apparatus having a function as a charging apparatus that charges a battery and a function as a feeding apparatus that feeds power from the battery. The charging and feeding apparatus is, for example, a stationary power storage apparatus installed in a site of a house, and is capable of charging a battery with electric power from a commercial power source and supplying the electric power to a load in the house with use of the electric power from the battery during an electric power outage.

FIG. 1 is a perspective view schematically illustrating an external appearance shape of a holding apparatus 100 according to an embodiment of the present invention. Hereinafter, for the sake of convenience, a front-rear direction (a length direction), a left-right direction (a width direction), and an up-down direction (a height direction) are defined as illustrated, and a configuration of each part will be described according to this definition. A lower side in the up-down direction (a vertical direction) corresponds to a gravity direction. The holding apparatus 100 is disposed outdoors, for example.

As illustrated in FIG. 1, the holding apparatus 100 includes an apparatus body 1, in which a pair of batteries 200 having identical configurations are housed. The apparatus body 1 includes a case 2 and a lid 3. The case 2 includes front, rear, left, and right side walls 2a to 2d, which extend in the up-down direction, that is, a front wall 2a, a left wall 2b, a rear wall 2c, and a right wall 2d, and a bottom wall 2e, which extends in the horizontal direction. The case 2 has a substantially rectangular parallelepiped shape as a whole. The case 2 and the lid 3 form a box-shaped space SP0. That is, the case 2 and the lid 3 constitute a housing. In FIG. 1, a part of the front wall 2a is removed and illustrated. The case 2 is installed on a horizontal placement surface 210 such as the ground via a pair of left and right base blocks 4. The bottom wall 2e is positioned above the placement surface 210 by the height of the base block 4.

The lid 3 is supported by an upper end portion of the rear wall 2c via a pair of left and right hinges 30 so as to be rotatable in the up-down direction about an axis CL1, which extends in the left-right direction. In FIG. 1, the lid 3 is opened. An upper plate 41 having a substantially rectangular shape in a plan view is disposed on an upper surface of the case 2 so as to cover an opening 21 having a substantially rectangular shape. Front, rear, left, and right end portions of the upper plate 41 are fixed to upper end portions of the front, rear, left, and right side walls 2a to 2d, and the upper surface of the case 2 is covered with the upper plate 41. Inside the case 2, a pair of left and right vertical frames 47 (upper sides are omitted from illustration), which are long and narrow in the up-down direction, are erected from the upper surface of the bottom wall 2e, in left and right corner portions on the front side of the case 2. A front end portion of the upper plate 41 may be fixed to upper end portions of the vertical frames 47.

A pair of left and right openings 411, which are insertion and removal ports of the batteries 200, are provided on the upper plate 41. The opening 411 has a substantially rectangular shape corresponding to the shape of the battery 200. An opening 412 having a substantially rectangular shape is provided on a further right side of the right opening 411, and a control panel 5 is disposed to close the opening 412. The control panel 5 includes: a display unit for displaying various types of information such as a charge state of the battery 200 and a use state of the holding apparatus 100; and an operation unit for inputting a setting command and the like into the holding apparatus 100. The control panel 5 can be constituted of a touch panel or the like in which the display unit and the operation unit are integrated together.

Inside the case 2, a pair of front and rear horizontal frames 42 and 43 extend from an inner surface of the left wall 2b to an inner surface of the right wall 2d. Both left and right end portions of the horizontal frame 42 are supported by the pair of left and right vertical frames 47 inside the case. The horizontal frame 43 is supported by side walls (the left wall 2b, the rear wall 2c, and the right wall 2d) of the case 2. A pair of left and right vertical frames that are long and narrow may be erected upward from the upper surface of the bottom wall 2e at the left and right corner portions on the rear side of the case 2, and both the left and right end portions of the horizontal frame 43 may be supported by the vertical frames.

A horizontal plate 44, which is a partition wall having a substantially rectangular shape in a plan view, is placed on the upper surfaces of the horizontal frames 42 and 43, and the horizontal plate 44 is supported by the horizontal frames 42 and 43. A left end portion and a rear end portion of the horizontal plate 44 respectively abut on the inner surface of the left wall 2b and the inner surface of the rear wall 2c of the case 2. Between a front end of the horizontal plate 44 and the inner surface of the front wall 2a, a gap having a predetermined length in the front-rear direction is provided over the entire length in the left-right direction.

The horizontal plate 44 extends substantially in parallel with the upper plate 41. The housing space SP0 inside the case is partitioned by the horizontal plate 44 into an upper space SP1 above the horizontal plate 44 and a lower space SP2 below the horizontal plate 44. A right end surface of the horizontal plate 44 is positioned on a right side of the right opening 411 of the upper plate 41. However, the length in the left-right direction of the horizontal plate 44 is shorter than the length in the left-right direction of the upper plate 41, and the right end surface of the horizontal plate 44 is positioned on a left side by a predetermined distance from the inner surface of the right wall 2d.

Between the right opening 411 of the upper plate 41 and the opening 412 on its right side, a vertical plate 45, which is a partition wall having a substantially rectangular shape, extends downward from a bottom surface of the upper plate 41. A rear end surface of the vertical plate 45 abuts on or is in close proximity to the inner surface of the rear wall 2c, and a lower end surface of the vertical plate 45 abuts on an upper surface of the horizontal plate 44. Accordingly, a side space SP3, which is defined by the vertical plate 45, is formed on a right side of the upper space SP1. There is no partition wall between the side space SP3 and the lower space SP2, and the side space SP3 and the lower space SP2 communicate with each other. In the upper space SP1, a pair of left and right holders 25 are disposed to respectively correspond to the positions of the openings 411 of the upper plate 41.

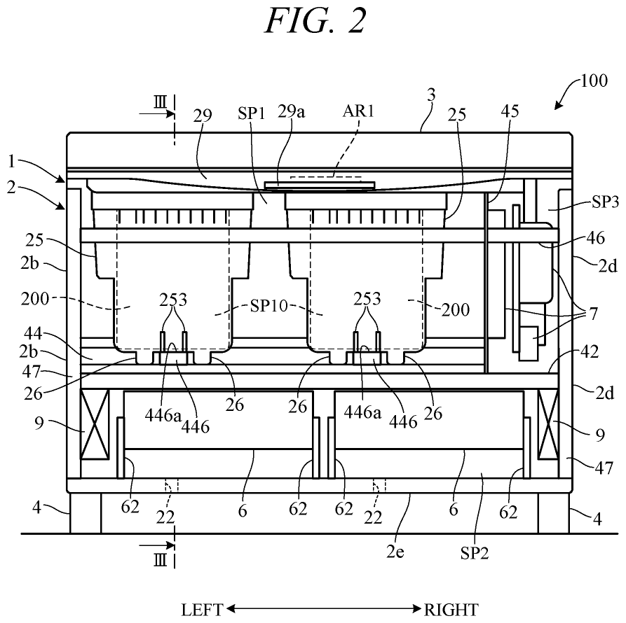

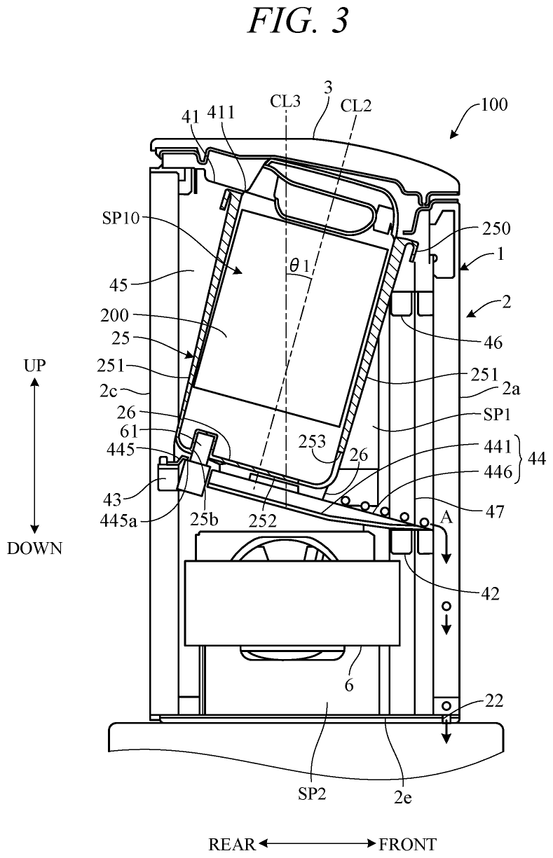

The front wall 2a is detachably attached to a front surface of the case 2 with bolts. FIG. 2 is a front view (viewed from a front side) of the apparatus body 1 in a state in which the front wall 2a is removed, and FIG. 3 is a cross-sectional view taken along line III-III in FIG. 2. In FIGS. 2 and 3, the lid 3 is closed. As illustrated in FIGS. 2 and 3, the holder 25 is a substantially box-shaped case with an upper surface opened, and is formed of a plate-shaped member that surrounds the battery 200.

That is, the holder 25 includes front, rear, left, and right side walls 251 and the bottom wall 252, which surround the battery 200, and forms a substantially box-shaped housing space SP10 corresponding to an outer shape of the battery 200. The battery 200 is inserted into the housing space SP10 of the holder 25 from above. On a bottom surface of the holder 25, leg portions 26 are provided to protrude downward from four positions that are a left front portion, a left rear portion, a right front portion, and a right rear portion. The leg portions 26 are fixed to the upper surface of the horizontal plate 44 (attachment portions 25a to be described later) with bolts that penetrate into the horizontal plate 44.

As illustrated in FIG. 3, the rear horizontal frame 43 that extends in the left-right direction is positioned on an upper side than the front horizontal frame 42. For this reason, the horizontal plate 44 extends to be inclined in a downward gradient toward the front side. The battery 200 is inserted into the holder along an axis CL2, which passes through the center of the bottom surface of the holder 25, and which is orthogonal to the bottom surface of the holder 25. The axis CL2 is inclined frontward by a predetermined angle θ1 (for example, 15 degrees) with respect to an axis CL3, which extends in the up-down direction. In this situation, an inclination angle of the horizontal plate 44, that is, an angle formed by the horizontal plate 44 with respect to the horizontal line is also the predetermined angle θ1.

In this manner, the holder 25 is fixed to the upper surface of the horizontal plate 44, which is inclined in a downward gradient toward the front side, and thus an opening at an upper end of the holder 25 faces upward and frontward. Therefore, in housing the battery 200 into the holder, it is sufficient for a user to insert the battery 200 obliquely with respect to the gravity direction along the axis CL2 from above and the front side of the case 2, and it is easy to insert the battery 200. As illustrated in FIG. 2, an upper frame 46 extends in the left-right direction above the horizontal frame 42, from the left wall 2b to the right wall 2d of the case 2. The upper frame 46 is supported by the side walls (the left wall 2b and the right wall 2d) of the case 2 or the vertical frames inside the case. As illustrated in FIG. 3, a front surface of the holder 25 abuts on the upper frame 46, and thus the holder 25 is stably supported.

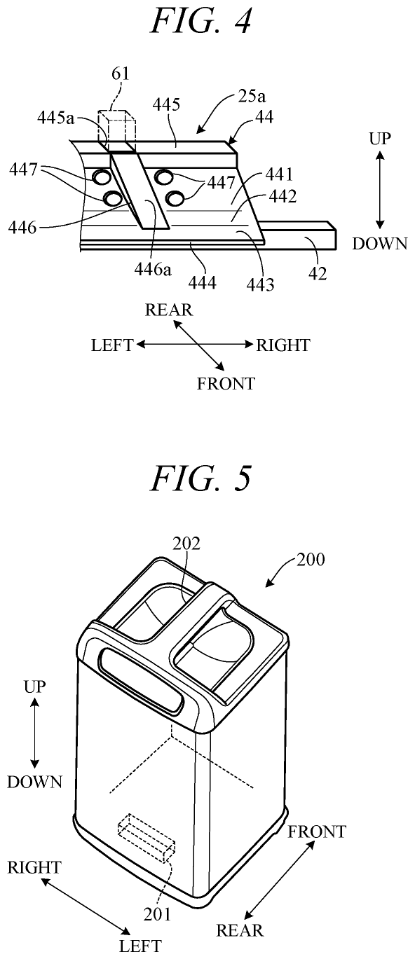

FIG. 4 is a perspective view (viewed from an obliquely left upper side) illustrating a configuration of a right end portion of the horizontal plate 44, and mainly illustrates a configuration of an attachment portion 25a of the holder 25 on the right side. Although not illustrated, the configuration of the attachment portion 25a of the holder 25 on the left side is also identical to that of FIG. 4, and the attachment portions 25a having the identical configurations are attached to the holder 25 at two positions in the left-right direction.

As illustrated in FIG. 4, the horizontal plate 44 includes: a central plate portion 441, which is inclined at the predetermined angle θ1 (for example, 15 degrees) with respect to the horizontal line, and which extends in the front-rear direction in a downward gradient toward the front side; a first small-inclined portion 442, which is bent on a front end portion of the central plate portion 441, and which extends frontward at an inclination angle smaller than that of the central plate portion 441; a second small-inclined portion 443, which is bent on a front end portion of the first small-inclined portion 442, and which extends frontward at an inclination angle (for example, an inclination angle 0 degrees) smaller than that of the first small-inclined portion 442; and a hang-down plate portion 444, which is bent on a front end portion of the second small-inclined portion 443, and which hangs down. A front end portion of the horizontal plate 44 protrudes frontward relative to the horizontal frame 42. As illustrated in FIG. 3, the position in the front-rear direction of the front end portion of the horizontal frame 42 and the position in the front-rear direction of a front end portion 250 of the holder 25 are identical to each other or substantially identical to each other. Therefore, the front end portion (the hang-down plate portion 444) of the horizontal plate 44 protrudes frontward relative to the front end portion 250 of the holder 25.

As illustrated in FIG. 4, the horizontal plate 44 is provided with a rib 445, which has a substantially letter L-shaped cross-section, and which is bent upward from a rear end portion of the central plate portion 441 and is further bent rearward from a part on an upper side of the central plate portion 441 by a predetermined height. The rear end portion of the rib 445 is further bent to be substantially horizontal toward the rear side, and is supported by the horizontal frame 43 on the rear side, as illustrated in FIG. 3. As illustrated in FIG. 4, a bulging portion 446, which has a substantially letter U-shaped cross-section, and which bulges upward from the central plate portion 441, is provided on the upper surface of the horizontal plate 44. The height of the rear end of the bulging portion 446 is equal to the height of the rib 445, and the bulging portion 446 is continuous with the rib 445 without a step.

The bulging portion 446 extends frontward from a front surface of the rib 445 to an upper surface of the second small-inclined portion 443 so as to have a constant width in the left-right direction. More specifically, the upper surface of the bulging portion 446 is configured as an inclined surface 446a, which extends at an inclination angle substantially parallel to the central plate portion 441. The rib 445 and the bulging portion 446 are provided continuously on the horizontal plate 44, so that the rigidity of the horizontal plate 44 can be enhanced.

On an upper surface of the central plate portion 441, a pair of left and right pedestals 447 are provided to interpose the bulging portion 446 on each of the front and rear sides to correspond to the positions of the leg portions 26 of the holder 25. A through hole that penetrates through the pedestal 447 in the up-down direction is opened in the pedestal 447, and the leg portion 26 of the holder 25 is fastened to the pedestal 447 with a bolt inserted into the through hole. Accordingly, the position of the holder 25 in the left-right direction is restricted, so that the holder 25 can be fixed at a predetermined position inside the case in a stable state. In a state in which the holder 25 is fixed, a bottom surface of the rear end portion of the bottom wall 252 abuts on an upper surface of the rib 445. Therefore, a front part and a central part in the front-rear direction of the holder 25 are supported by the central plate portion 441 via the leg portions 26, and a rear part of the holder 25 is supported by the rib 445.

A through hole 445a, which penetrates through the rib 445 in the up-down direction, is opened in the rib 445 on a rear side of the bulging portion 446. As illustrated in FIG. 3, in the bottom wall 252 of the holder 25, a through hole 25b, which penetrates through the bottom wall 252 in the up-down direction, is opened at an identical position to the through hole 445a. From below the rib 445, a plug 61 having a protrusion shape protrudes upward relative to an upper end surface of the rib 445 through the through holes 445a and 25b. The plug 61 is a male terminal including an electrode, and is connected to an inverter unit 6 through a cable, not illustrated.

FIG. 5 is a perspective view illustrating an overall configuration of the battery 200. In FIG. 5, a front-rear direction, a left-right direction, and an up-down direction are defined to correspond to the attitude of the battery 200 in FIG. 3. As illustrated in FIG. 3, the battery 200 has a length in the up-down direction longer than lengths in the front-rear direction and the left-right direction, and is formed in a substantially rectangular parallelepiped shape as a whole. The battery 200 is, for example, a storage battery such as a lithium ion battery, that is, a secondary battery. On the bottom surface of the battery 200, a receptacle 201 having a recess shape is provided on a rear side of the central part in the front-rear direction. The receptacle 201 includes an electrode disposed in a recess portion provided on the bottom surface of the battery 200, and is configured as a female terminal.

The battery 200 is a portable battery having a weight of, for example, about 10 kg, and a handle 202 to be gripped by a user is provided on an upper part of the battery 200. The handle 202 is provided at the central part in the left-right direction so as to extend in the front-rear direction. The weight of the battery 200 may be heavier or lighter than 10 kg. The user grips the handle 202, lifts up the battery 200, and is able to insert the battery 200 into the holder and remove the battery 200 from the holder 25. When the battery 200 is inserted into the holder, the plug 61 is fitted into the receptacle 201 on the bottom surface of the battery 200, and the electrodes are connected with each other.

As illustrated in FIG. 2, a pair of left and right inverter units 6 are respectively disposed in the lower space SP2 of the case 2 via stays 62, which are erected from the bottom wall 2e. The inverter units 6 on the left and right sides are respectively connected with the batteries 200 on the left and right sides through a pair of left and right plugs 61 (FIG. 3). Front end portions of the inverter units 6 are positioned on a rear side of the front end surface of the horizontal frame 42. As long as the front end portion of the inverter unit 6 is positioned on the rear side of the front end portion of the horizontal plate 44, the front end portion may not necessarily be positioned on the rear side of the front end surface of the horizontal frame 42.

The inverter unit 6 is provided on a way of a power transmission path from a commercial power source to the battery 200 and on a way of a power transmission path from the battery 200 to a load. The inverter unit 6 includes an AC/DC inverter and a DC/DC converter, and is a power conversion device provided to be capable of transmitting the power to and from the battery 200. AC power from the commercial power supply is converted into a direct current of a predetermined voltage by the inverter unit 6, and is supplied to the battery 200. Accordingly, the battery 200 is charged. DC power from the battery 200 is converted into an alternating current of a predetermined voltage by the inverter unit 6, and is supplied to the load. Accordingly, the battery 200 is discharged.

In the side space SP3, various electric component parts 7 such as an electronic control unit (ECU), a junction box, and a bus through circuit are disposed. Although not illustrated, in the holding apparatus 100, an input terminal into which the AC power is input and an output terminal from which the AC power is output are provided. For example, a male plug is provided on the input terminal. The holding apparatus 100 is connected to a commercial power supply through the electric component part 7 and the plug, and the AC power is supplied from the commercial power supply to the holding apparatus 100. For example, a female socket is provided on the output terminal. The holding apparatus 100 is connected to the load through the electric component part 7 and the socket, and the AC power is output from the holding apparatus 100 to the load.

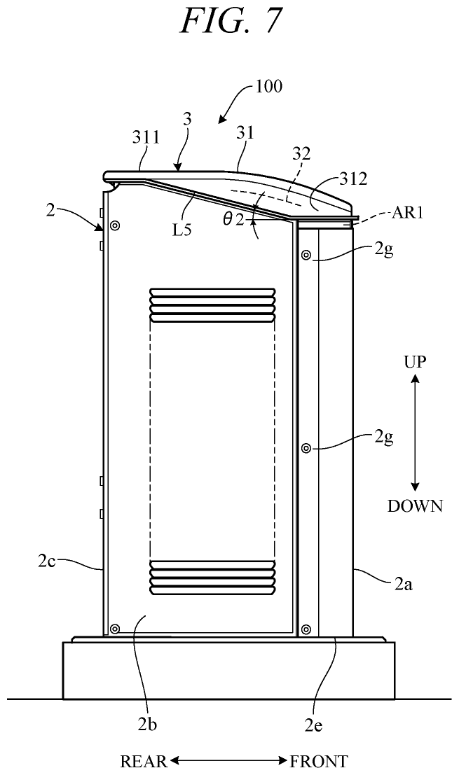

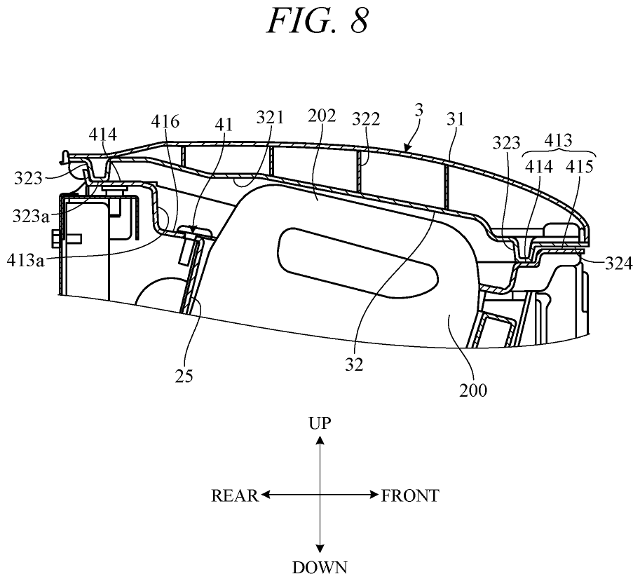

Cooling fans 9 are respectively attached to the inner surfaces in the left-right direction of the left wall 2b and the right wall 2d so as to face the inverter units 6. The cooling air flows inside the housing space SP0 by the rotation of the cooling fans 9, and a cooling effect for cooling the inverter units 6 and the electric component parts 7 is obtained. As illustrated in FIG. 2, an upper panel 29 is provided between the lid 3 and the front wall 2a (FIG. 3) below a front end portion of the lid 3, from the left wall 2b to the right wall 2d. Both left and right end portions of the upper panel 29 are respectively fixed to the vertical frames 47. A lamp 29a such as an LED for notifying a charge state of the battery 200 is provided in a central part of the upper panel 29. An area AR1 (see FIG. 7), which is recessed rearward, is provided between the lid 3 and the lamp 29a. The user inserts a finger into the area AR1, and is able to lift up the lid 3.

As illustrated in FIGS. 2 and 3, a pair of left and right slit holes 253, which penetrate into the holder 25, are provided at corner portions in which the side wall 251 on the front side of the holder 25 and the bottom wall 252 intersect with each other. That is, in the corner portion that is a lowermost part of the holder 25, the slit hole 253, which is long and narrow, is provided from a part on an upper side, by a predetermined length, of a lower end of the side wall 251 on the front side to a part on a rear side, by a predetermined length, of the front end of the bottom wall 252.

As illustrated in FIG. 2, the slit hole 253 is positioned on an inner side in the left-right direction than both end portions in the left-right direction of the bulging portion 446 of the horizontal plate 44. The slit hole 253 has a width in the left-right direction of about several millimeters to several centimeters, so that water can easily pass through the slit hole 253. This causes the water such as raindrops that have entered the inside of the holder to flow out of the holder 25 through the slit hole 253. The water that has flowed out flows frontward along the inclined surface 446a, which is the upper surface of the bulging portion 446, and drops from the front end portion of the horizontal plate 44, as indicated by an arrow A in FIG. 3. The water that has dropped is discharged to the outside of the case 2 through a drain port 22, which penetrates in the up-down direction through a front end portion of the bottom wall 2e.

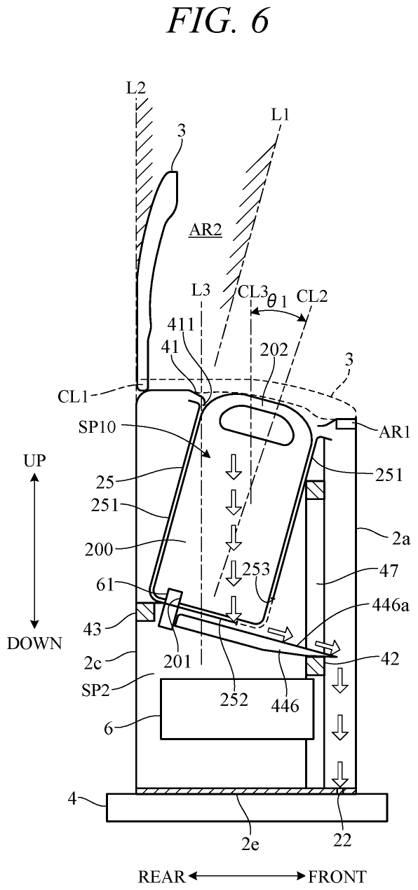

FIG. 6 is a diagram for describing operations and effects of the holding apparatus 100 according to an embodiment of the present invention. As illustrated in FIG. 6, when the battery 200 is inserted into the holder 25 inside the case or the battery 200 is removed from the holder 25, the lid 3 in a closed position (a dotted line) is opened. In this case, the user inserts a finger into a recess-shaped space (the area AR1) between the front end portion of the lid 3 and an upper end of the front wall 2a, and lifts up the lid 3. Then, the lid 3 rotates rearward about the axis CL1, and is in an open position (a solid line).

The holder 25 is held inside the case in an inclined attitude inclined frontward by the predetermined angle θ1 with respect to the axis CL3 in the vertical direction. Therefore, the axis CL2, which passes through the center of the housing space SP10 of the battery 200 provided in the holder 25, obliquely extends upward and frontward. Therefore, before inserting the battery 200, the user is able to visually confirm easily a state inside the housing space SP10 of the holder 25 (a state of whether the plug 61 protrudes normally or the like). When inserting the battery 200 into the housing space SP10, the user grips the handle 202 and lifts up the battery 200 (moves upward) in a state in which the lid 3 is opened. Then, the user inserts the battery 200 into the housing space SP10 along the axis CL2 (moves rearward) through the opening 411 of the upper plate 41, and slides the battery 200 downward along an inner surface of the side wall 251 of the holder 25, until the plug 61 is fitted into the receptacle 201 on the bottom surface.

Therefore, the amount of upward and rearward movements of the battery 200 at the time when the user inserts the battery is smaller than that of a case where the opening 411 faces upward with no inclination of the axis CL2. Therefore, the labor of the user at the time of inserting the battery can be reduced. In addition, the battery 200 moves downward while sliding along the inner surface of the side wall 251 of the holder 25, so that the descending speed of the battery 200 can be suppressed, and the plug 61 can be slowly fitted into the receptacle 201. This enables prevention of damage on the electrodes of the receptacle 201 and the plug 61. The opening 411, which is the insertion and removal port of the battery 200, of the upper plate 41, faces upward and frontward, so that the user can easily and satisfactorily insert the battery 200 into the housing space SP10, while confirming the positional relationship between the battery 200 and the opening 411.

In a case where a reference line L1 parallel to the axis CL2 is defined along the inner surface of the side wall 251 on the rear side of the holder 25, the space on the front side of the reference line L1 is a minimum space necessary for insertion and removal of the battery 200. In other words, in the space above the lid 3, there is a free space on a rear side of the reference line L1. The reference line L1 is inclined frontward with respect to a vertical line L3, and a wide free space can be ensured. The open position of the lid 3 is set with use of this free space. That is, the open position of the lid 3 is set in an area AR2 (hatching) between the reference line L1 and a vertical line L2 along a rear surface of the rear wall 2c.

An installation space of the holding apparatus 100 can be saved, accordingly. That is, if the open position of the lid 3 is on a rear side of the vertical line L2, a space of a corresponding amount for enabling an open operation of the lid 3 is necessary on a rear side of the holding apparatus 100, and the installation space of the holding apparatus 100 will be enlarged. In this regard, in the case where the open position of the lid 3 is on a front side of the vertical line L2 as in the present embodiment, the installation space on the rear side of the holding apparatus 100 can be reduced.

The holding apparatus 100 is installed outdoors. Hence, when the lid 3 is opened, raindrops may enter the inside of the housing space SP10 of the holder 25 through the opening 411 of the upper plate 41. When raindrops enter the inside of the housing space, such raindrops flow frontward and downward along the bottom wall 252 of the holder 25, as indicated by arrows in FIG. 6, and flow out of the holder 25 through the slit hole 253 at the corner portion of the front end of the holder 25. The raindrops that have flowed out flow frontward and downward along the upper surface (the inclined surface 446a) of the bulging portion 446 of the horizontal plate 44, and drop on a front side of the horizontal frame 42. The water that has dropped is discharged to the outside through the drain port 22 of the bottom wall 2e.

Accordingly, the raindrops that have flowed into the holder are collected in the space on a front lower side of the holding apparatus 100, so that the raindrops can be efficiently discharged from the holding apparatus 100. In particular, the bottom wall 252 of the holder 25 and the inclined surface 446a of the horizontal plate 44 extend in the front-rear direction at identical inclination angles, and the momentum of the flow of the water that has flowed out of the holder 25 is not weakened while the water is flowing through the inclined surface 446a of the horizontal plate 44, so that the momentum of the flow of the water can be favorably maintained. In addition, a drain passage from the holder 25 to the drain port 22 is short, so that the raindrops that have entered through the opening 411 can be efficiently discharged to the outside of the holding apparatus 100 with a simple configuration.

The front end portion of the horizontal plate 44 protrudes frontward relative to the horizontal frame 42, so that the surface of the inverter unit 6, which is disposed in the lower space SP2 of the horizontal plate 44, can be prevented from getting wet, and a good waterproof effect for the inverter unit 6 is obtained. The plug 61, which penetrates through the bottom wall 252 of the holder 25 and protrudes upward, is positioned on a rear side of the vertical line L3, which passes through rear end portions of the openings 411 of the upper plate 41. Therefore, the plug 61 and a receptacle 203 can be prevented from getting wet with the raindrops that have flowed in from the openings 411, and a good waterproof effect for the electrode is obtained.

Both left and right end portions of the front wall 2a are bent rearward (see FIG. 7). Therefore, both left and right end portions of the front wall 2a protrude rearward, and the protrusion portions are fastened to the left and right side walls 2b and 2d by bolts 2g. Therefore, a space for discharging the water that has dropped from the front end portion of the inclined surface 446a can be formed easily between the vertical frames 47 and the horizontal frame 42 and the front wall 2a. In addition, it is sufficient to open the drain port 22 on the bottom wall 2e so as to face such a space, so that the drain port 22 can also be easily provided.

According to the present embodiment, the following operations and effects are achievable.

(1) The holding apparatus 100 includes: the holder 25 that holds the battery 200 to be detachable; and the case 2 provided to house the holder 25 (FIG. 1). The holder 25 is provided such that an attachment and detachment direction (a direction along the axis CL2) in which the battery 200 is attached to or detached from the holder 25 is inclined with respect to a direction (a direction along the axis CL3) orthogonal to the placement surface 210 of the case 2 (FIG. 3).

Accordingly, the battery 200 can be easily attached and detached, as compared with a case where the attachment and detachment direction of the battery 200 is the vertical direction. In addition, a space above and on a front side of the holding apparatus 100 is used for attaching and detaching the battery 200, and a space above and on a rear side of the holding apparatus 100 (the area AR2 in FIG. 6) is a free space. Therefore, the lid 3 in an open attitude can be easily disposed in such a free space, so that the space above the holding apparatus 100 can be efficiently used. That is, the holding apparatus 100 can be provided with good space efficiency. Furthermore, the holder 25 is fixed to the case 2 and it is not necessary to rotate the holder 25 frontward. This eliminates the need for ensuring a space for rotating the holder 25 toward the front side of the holding apparatus 100. Therefore, the configuration of the holding apparatus 100 is simplified, an increase in cost can be suppressed, and an increase in the installation space of the holding apparatus 100 can be suppressed.

(2) The holding apparatus 100 further includes: the inverter unit 6, which is provided to be capable of transmitting electric power to and from the battery 200 held by the holder 25; and the horizontal plate 44, which defines the upper space SP1, in which the holder 25 is disposed, and the lower space SP2, in which the inverter unit 6 is disposed, in the case 2 (FIG. 1). In this manner, the battery 200 and the inverter unit 6 are disposed in different spaces SP1 and SP2 by the horizontal plate 44. When the battery 200 gets wet with water, the inverter unit 6 can be suppressed from getting wet at the same time.

(3) The inverter unit 6 is disposed below the holder 25 (FIG. 1). The horizontal plate 44 is disposed below the holder 25 and above the inverter unit 6 (FIG. 1). Accordingly, while easiness of attachment and detachment of the battery 200 is ensured, it is possible to prevent the inverter unit 6 from getting wet, after the water in the vicinity of the battery 200 drops due to gravity.

(4) The horizontal plate 44 is provided to extend in the direction orthogonal to the attachment and detachment direction of the battery 200 (FIG. 3). Accordingly, the angle formed by the horizontal plate 44 and the horizontal line becomes the predetermined angle θ1, and the horizontal plate 44 is inclined in a downward gradient toward the front side, so that the raindrops that have entered the inside of the holder can be easily discharged to the outside of the holding apparatus 100 along the horizontal plate 44.

(5) The horizontal plate 44 is provided such that the front end portion (the hang-down plate portion 444) of the horizontal plate 44 is positioned on the front side of the front end portion 250 of the holder 25, the front end portion being a side on which the attachment and detachment direction (the direction along the axis CL2) of the battery 200 is inclined with respect to the direction (the direction along the axis CL3) orthogonal to the placement surface 210 (FIGS. 3 and 4). Accordingly, the water that has entered the inside of the holder can be guided to the front side of the front end portion of the holder 25 via the horizontal plate 44, that is, to the most front side as much as possible in the holding apparatus. Therefore, the other component parts in the holding apparatus can be prevented from getting wet with water.

(6) The drain port 22, which communicates the inside and the outside of the case 2, is provided at a position below the front end portion of the horizontal plate 44 (FIG. 3). Accordingly, the water that has dropped from the front end portion of the horizontal plate 44 can be satisfactorily discharged to the outside of the case 2 through the drain port 22.

(7) The horizontal plate 44 includes the bulging portion 446, which is provided to protrude upward from the upper surface that faces the holder 25 (FIG. 4). Accordingly, the rigidity of the horizontal plate 44 can be enhanced, and in addition, the bulging portion 446 can be configured as a drain passage from the holder 25.

(8) The bulging portion 446 includes the inclined surface 446a, which is provided to be inclined with respect to the horizontal direction, and is disposed at a position corresponding to the slit hole 253, which communicates the inside and the outside of the holder 25 (FIGS. 2 to 4). Accordingly, the water that has flowed out of the slit hole 253 flows along the inclined surface 446a, and good drainage is enabled.

(9) The inclined surface 446a is inclined in a downward gradient from the rear end portion to the front end portion (FIG. 3). The plug 61, which is a terminal portion to be electrically connected with the battery 200, is disposed on a rear side of the rear end portion of the inclined surface 446a (FIGS. 3 and 4). Accordingly, the plug 61 is disposed on an opposite side to the drain direction, so that the plug 61 can be prevented from getting wet.

(10) The holder 25 includes the leg portion 26, which is provided to protrude downward from the bottom surface of the bottom wall 252, which faces the horizontal plate 44 (FIGS. 2 and 3). The leg portion 26 is disposed at a position adjacent to the bulging portion 446 of the horizontal plate 44 (FIG. 2). Accordingly, the holder 25 can be positioned via the bulging portion 446.

(11) The holder 25 includes the pair of left and right leg portions 26 (FIG. 2). The pair of left and right leg portions 26 are disposed on both sides in the left-right direction of the bulging portion 446 of the horizontal plate 44. Accordingly, the position in the left-right direction of the holder 25 can be satisfactorily defined.

(12) The holding apparatus 100 further includes: the electric component part 7 to be electrically connected to the inverter unit 6; and the vertical plate 45, which defines the upper space SP1, in which the holder 25 above the horizontal plate 44 is disposed, and the side space SP3, in which the electric component part 7 is disposed, in the case 2 (FIG. 2). Accordingly, the holder 25 and the electric component part 7 are disposed in different spaces (SP1 and SP3) interposing the vertical plate 45, so that the electric component part 7 can be prevented from getting wet.

(13) The holder 25 includes the side wall 251 and the bottom wall 252, which surround the battery 200 (FIG. 3). In the corner portion between the side wall 251 on the front side and the bottom wall 252, the slit hole 253, which is long and narrow in the front-rear direction and the up-down direction, is opened (FIG. 3). Accordingly, the water inside the holder that has flowed along the bottom wall 252 of the holder 25 can be satisfactorily guided through the slit hole 253 to the inclined surface 446a, which is the upper surface of the bulging portion 446.

The holding apparatus 100 according to the present embodiment also has a characteristic configuration also in the lid 3 and its peripheral part. Hereinafter, such a configuration will be described. FIG. 7 is a side view (viewed from a left side) illustrating an outer appearance shape of the holding apparatus 100 according to an embodiment of the present invention, and FIG. 8 is a cross-sectional view of an upper part of FIG. 7. FIGS. 7 and 8 illustrate a state in which the lid 3 is closed. As illustrated in FIG. 8, the lid 3 includes: an upper lid 31 having a substantially rectangular shape in a plan view; and a lower lid 32. Front, rear, left, and right peripheral parts of the upper lid 31 and the lower lid 32 are coupled with each other, and the upper lid and the lower lid are integrated together.

As illustrated in FIG. 7, the upper lid 31 includes: an upper surface portion 311, which constitutes an upper surface of the lid 3 in the closed state; and side surface portions 312, which are bent downward from both left and right end portions of the upper surface portion 311. The upper surface portion 311 is formed in a curved surface shape that is gentle as a whole in the front-rear direction. More specifically, the upper surface portion 311 is formed in a convex curved surface shape toward an upper side so that an inclination angle of the upper surface portion 311 with respect to the horizontal line gradually increases from a rear end to a front end. Accordingly, a recess-shaped space is formed on inner sides of the left and right side surface portions 312 on a lower surface of the upper lid 31.

The upper surface portion 311 is formed in a curved surface shape. Therefore, it is not possible to place an object on the upper surface of the lid 3, and it is possible to open the lid 3 and then attach and detach the battery 200 immediately. On the other hand, in a case where the upper surface of the lid 3 is configured as a flat surface along a horizontal plane, an object is placed on the upper surface of the lid 3, in some cases. In such cases, when opening and closing the lid 3, it is necessary to remove such an object from the upper surface of the lid 3, and it is not possible to attach or detach the battery 200 immediately. In addition, in a case where an object placed on the upper surface of the lid 3 is a heavy one, the lid 3 may be deformed, and a seal portion on which the lid 3 and the case 2 abut may be damaged.

A boundary line L5 between the left and right side walls (the left wall 2b and the right wall 2d) of the case 2 and the lid 3, that is, the boundary line L5 along an upper end surface of the case 2 or along a lower end surface of the side surface portion 312 is inclined in a downward gradient toward a front side at a predetermined angle θ2 with respect to the horizontal line. The angle θ2 is substantially equal to the inclination angle (the angle θ1) of the horizontal plate 44.

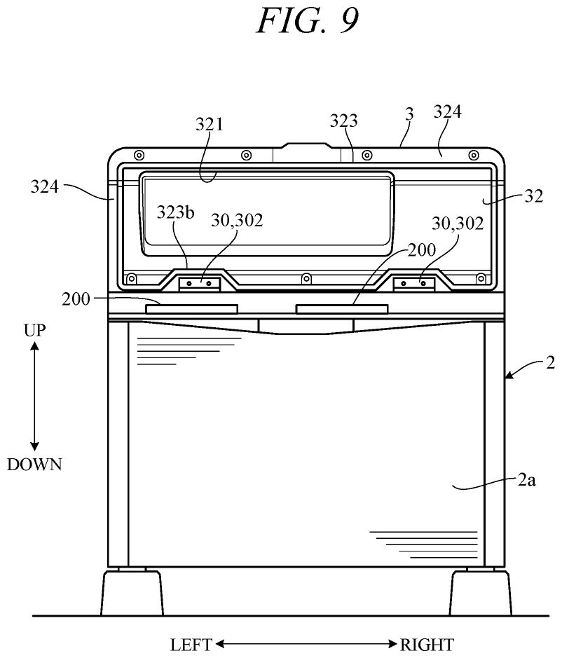

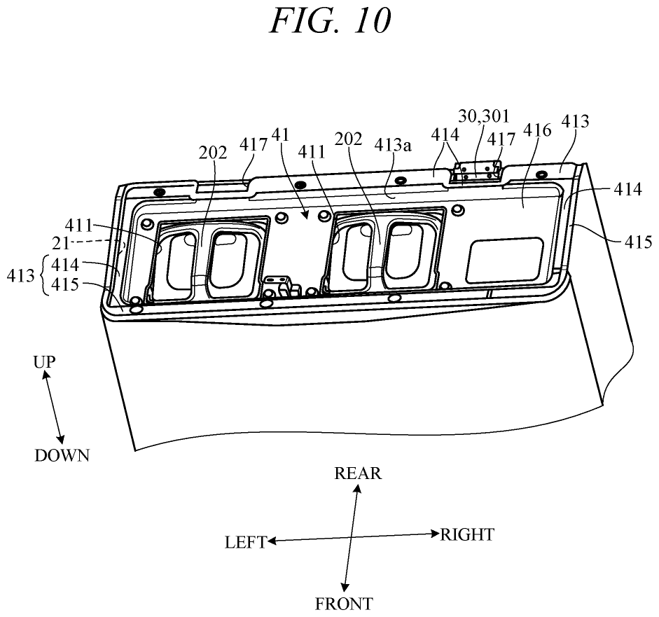

FIG. 9 is a front view (viewed from the front side) of the holding apparatus 100 in a state in which the lid 3 is open, and FIG. 10 is a perspective view of the upper plate 41, which covers the opening 21 having a substantially rectangular shape on the upper surface of the case 2, in a state in which the lid 3 is removed, when viewed from an obliquely right upper side. As illustrated in FIGS. 8 and 10, the upper plate 41 includes: a flange portion 413, which has a substantially rectangular frame shape in a plan view, and which is provided in a peripheral edge portion of the upper plate 41; and a cover portion 416 on an inner side of the flange portion 413.

An upper surface of the cover portion 416 is positioned on a lower side of the upper surface of the flange portion 413 by a predetermined height, and an upper surface of the upper plate 41 is formed in a recess shape. The upper surface of the cover portion 416 is a flat surface that extends substantially parallel to the boundary line L5 (FIG. 7). The upper surface of the upper plate 41 is configured in the recess shape, so that the handle 202 on an upper end portion of the battery 200 can be made to protrude upward relative to the upper surface of the cover portion 416 from the left and right openings 411 of the cover portion 416. This enables the user to easily hold the handle 202 and to easily attach and detach the battery 200.

As illustrated in FIGS. 8 and 9, a recessed portion 321, which has a substantially rectangular shape, and which is recessed upward, is provided on a lower surface of the lower lid 32 so as to correspond to the position of the battery 200. As illustrated in FIG. 8, the recessed portion 321 is provided not to contact the upper end portion of the battery 200, that is, so as to define a predetermined gap in the up-down direction from the upper end portion of the battery 200. For example, in a case where fitting between the plug 61 and the receptacle 201 in FIG. 6 is incomplete and the battery 200 is displaced from a normal housing position, it is impossible to close the lid 3. Therefore, the user is able to determine whether the battery 200 is in the normal housing position depending on whether it is possible to easily close the lid 3. A plurality of ribs 322 protrude upward from an upper surface of the lower lid 32, and a space between the upper lid 31 and the lower lid 32 is filled with the ribs 322. This enables enhancement of the rigidity of the lid 3.

As illustrated in FIG. 10, the flange portion 413 of the upper plate 41 includes: an inner flange portion 414, which has a substantially rectangular frame shape that surrounds the entire periphery of the cover portion 416 via a stepped portion 413a, which extends in the up-down direction; and an outer flange portion 415, which is provided on an outer side in the left-right direction and on a front side of the inner flange portion 414, and which extends along a plane on an upper side of the inner flange portion 414 by a predetermined height. As illustrated in FIG. 9, on the lower surface of the lid 3 (the lower lid 32), a protrusion portion 323, which has a substantially rectangular frame shape, and which protrudes downward to correspond to the position of the inner flange portion 414, is provided. A flange portion 324, which extends along a plane to correspond to the position of the outer flange portion 415, is provided on an outer side in the left-right direction and on a front side of the protrusion portion 323.

As illustrated in FIG. 8, when the lid 3 is closed, the protrusion portion 323 abuts on the inner flange portion 414. A seal material 323a is attached beforehand to a lower surface of the protrusion portion 323, and the inner flange portion 414 and the protrusion portion 323 abut on each other through the seal material 323a. The seal material 323a can be constituted of an elastic body. Instead of a tip end portion of the protrusion portion 323 or in addition to the tip end portion of the protrusion portion 323, a seal material may be attached to an upper surface of the inner flange portion 414.

In this manner, the inner flange portion 414 and the protrusion portion 323 abut on each other through the seal material 323a, and thus a gap between the lid 3 and the case 2 is closed, so that raindrops or the like can be prevented from entering the inside of the case from the outside. In a case where the gap between the inner flange portion 414 and the protrusion portion 323 is minute, the seal material 323a can be omitted. In a state in which the inner flange portion 414 and the protrusion portion 323 abut on each other, the outer flange portion 415 and the flange portion 324 on the outer side face each other with a gap in the up-down direction.

As illustrated in FIG. 10, a pair of left and right recessed portions 417, which are recessed downward relative to the upper surface of the inner flange portion 414, are provided in a rear end portion of the upper plate 41. One plate portion 301 of a pair of left and right hinges 30 (only the right hinge 30 is illustrated in FIG. 10), which include a pair of plate portions 301 and 302, is fixed to each of the recessed portions 417. Also on a front side of the recessed portion 417, the inner flange portion 414 having a short length in the front-rear direction is provided along the recessed portion 417 so as to be continuous with the inner flange portion 414 on an outer side in the left-right direction of the recessed portion 417.

As illustrated in FIG. 9, the other plate portion 302 of the pair of left and right hinges 30 is fixed to the lower surface of the lid 3. For example, a recessed portion is provided on the lower surface of the lid 3, and the plate portion 302 is fixed to the recessed portion. The protrusion portion 323 is bent partway to pass through an inner side (a front side) of the hinge 30. The protrusion portion 323 (323b) on the front side of the hinge 30 abuts on the inner flange portion 414 on the front side of the hinge 30 in FIG. 10. In this configuration, the protrusion portion 323 and the inner flange portion 414 abut on each other over the entire periphery without interfering with the hinge 30.

The hinge 30 is disposed between the upper plate 41 and the lid 3, and thus has high durability without being exposed to the outside, when the lid 3 is in the closed state. In addition, the hinge 30 is fixed to the recessed portion 417, which is formed on the upper surface of the inner flange portion 414. Therefore, the hinge 30 can be appropriately disposed between the upper plate 41 and the lid 3 without the thickness of the hinge 30 preventing opening and closing of the lid 3.

According to the present embodiment, the following operations and effects are further achievable.

(1) The holding apparatus 100 includes: the holder 25, which holds the battery 200 to be detachable; and the housing provided to house the holder 25 (FIG. 1). The housing includes: the case 2, which houses the holder 25; and the lid 3, which is provided to be openable and closable with respect to the case 2, and which covers an opening for inserting and removing the battery 200 on the upper surface of the holder 25 (FIG. 1). The lid 3 includes, on its lower surface that faces the case side in the closed state, the recessed portion 321, which is recessed to avoid the battery 200 held by the holder 25 (FIGS. 8 and 9).

This easily enables prevention of interference between the battery 200, which is housed in the holder 25, and the lid 3. That is, the battery 200 is housed in the holder 25 so as to be easily detachable from the holder 25, in a state in which the handle 202 on the upper end portion protrudes. Therefore, in trying to avoid the interference between the battery 200 and the lid 3, the lid 3 tends to increase in size. However, in the present embodiment, the recessed portion 321 is provided on the lower surface of the lid 3, so that the entire holding apparatus can be made compact without the increase in size of the lid 3.

(2) The recessed portion 321 is provided to overlap the battery 200, which is held by the holder 25 in the closed state of the lid 3 (FIGS. 8 and 9). This enables prevention of the interference between the battery 200 and the lid 3 satisfactorily, and in addition, the periphery of the upper end portion of the battery 200 is covered with the recessed portion 321 in the closed state of the lid 3, so that a holding function of the battery 200 is also obtained.

(3) The lid 3 includes the upper surface portion 311 having a curved surface shape on a surface that faces an opposite side to the case 2 in the closed state, that is, on the upper surface (FIG. 7). This enables prevention of an object from being placed on the upper surface of the lid 3, so that the battery 200 can be attached and detached promptly.

(4) The case 2 is placed below the lid 3, and the lid 3 is provided to extend in a substantially horizontal direction in the closed state (FIG. 7). In this configuration, the upper surface of the lid 3 is configured along a flat horizontal plane, in many cases. However, in the present embodiment, the upper surface of the lid 3 is configured to be a curved surface shape as described above. Therefore, it is not possible to place an object on the upper surface of the lid 3, so that the lid 3 can be opened promptly.

(5) The upper surface portion 311 of the lid 3 is provided to be inclined with respect to the horizontal direction (FIG. 7). Therefore, the lid 3 can be favorably configured to correspond to the inclination of an insertion and removal direction (the direction along the axis CL2 in FIG. 3) of the battery 200.

(6) In the case 2, the opening 21 is provided on the upper surface that is an end portion on the lid 3 side (FIG. 10). In the holding apparatus 100, the opening 411 is provided in the position corresponding to the opening of the holder 25 for inserting and removing the battery 200. The holding apparatus 100 further includes the upper plate 41, which closes a part of the opening 21 on the upper surface of the lid 3 (FIG. 10). Accordingly, parts other than the portion necessary for attaching and detaching the battery 200 can be covered with the upper plate 41, so that foreign matter can be prevented from entering the inside of the case from above.

(7) The holding apparatus 100 further includes the seal material 323a, which is interposed between the lower surface of the lid 3 that faces the case 2 side and the upper surface of the upper plate 41 that faces the lid 3 side in the closed state of the lid 3 (FIG. 8). In this configuration, the gap between the lid 3 and the case 2 is sealed in the closed state of the lid 3, so that raindrops can be satisfactorily prevented from entering the inside of the case.

(8) The holding apparatus 100 further includes the hinge 30, which couples the lid 3 with the case 2 so as to be openable and closable. The plate portion 302 on one side of the hinge 30 is fixed to a surface of the lid 3 that faces the case 2 side, that is, the lower surface of the lid 3 (FIG. 9). The plate portion 301 on the other side of the hinge 30 is fixed to a surface of the case 2 that faces the lid 3 side, that is, the upper surface of the upper plate 41 (FIG. 10). This enables prevention of the hinge 30 from being exposed to the outside, so that the durability of the holding apparatus 100, in particular, the durability of the periphery of the hinge 30 can be enhanced.

(9) The upper plate 41 includes the recessed portion 417, which is provided to avoid the hinge 30 (FIG. 10). This enables the lid 3 to be easily opened and closed without the hinge 30 interfering with other component parts.

The above embodiments can be modified in various modes. Hereinafter, modifications will be described. In the above embodiment, the battery 200 is held by the holder 25, but a capacitor may be held by the holder 25, and the configuration of the power storage device is not limited to those described above. In the above embodiment, the holder 25 is configured in a substantially box-shaped from so as to surround the battery 200 as a power storage device. In particular, the battery 200 is configured to be held in a detachable manner, but the configuration of the holder is not limited to those described above as long as the power storage device is held in a detachable manner. The power storage battery may be held with a portion of the power storage battery exposed to the outside. The entire of holder may not be composed of a plate-shaped member, but part of holder may be composed of a frame member. Detachable manner means that the power storage device can be attached and detached without the need for separate tools or the like.

In the above embodiment, a plurality of frames 42, 43 and 47 extending vertically and horizontally and a plurality of side walls 2a to 2d and bottom wall 2e, etc., constitute the case 2 housing the holder 25, but the arrangement and number of frames are not limited to those mentioned above, and any configuration of the housing is possible. In the above embodiment, the holder 25 is arranged so that the direction in which the battery 200 is attached and detached, that is, the direction of the axis CL2, is upward and forward in the side view. However, the direction of attachment and detachment may be in a direction other than those described above, as long as the holder 25 is provided to be inclined to the direction orthogonal to the placement surface 210 of the case 2. In the above embodiment, the case 2 is a horizontal bottom wall 2e, but the bottom wall can be omitted.

In the above embodiment, the space (placement space) SP1 in which the holder 25 is placed and the space (placement space) SP2 in which the inverter unit 6 as a power conversion device is placed are defined vertically through the horizontal plate 44, but the defining portion (first defining portion) may define these spaces in a manner other than vertically. In the above embodiment, the horizontal plate 44 is extended in a direction orthogonal to the direction of attachment and detachment of the battery 200, but the direction in which the compartment section is extended is not limited to that described above. In the above embodiment, the horizontal plate 44 is provided so that the end of the horizontal plate 44 in the front side (first side) is provided forward of the end of the holder 25 in the front side, but as long as the defining portion may only protrude to the first side more than the end on the first side of the component (inverter unit) 6 disposed in the lower space SP2, the defining portion may not protrude from the end of the housing on the first side. In a case the inclined surface 446a is provided on the top surface of the horizontal plate 44 to serve as a water drain passage, as in the above embodiment, water falls from the front end of the inclined surface 446a. Therefore, since water falling from the front end of the inclined surface 446a does not hit an area except for below the front end of the inclined surface 446a, components disposed in the lower space SP2 may partially protrude forward from the front end of the horizontal plate 44 in the area except for below the inclined surface 446a.

In the above embodiment, the drain port 22 is opened at the front end of the bottom wall 2e, but the position of the communication hole connecting the inside and outside of the housing is not limited to those described above. In the above embodiment, a bulging portion 446 protruding upwardly from the upper surface of the horizontal plate 44 is provided, but the convex portion can be omitted. In the above embodiment, a pair of left and right slit holes 253 on the corner of the holder 25 on the front side are provided to connect the inside and outside of the holder 25, but the configuration of the communication hole in the holder is not limited to this. In the above embodiment, the inclined surface 446a is provided on the top surface of the bulging portion 446 so that inclined surface 446a slopes downward from the rear end to the front end, and a plug 61 as a terminal position is disposed between the rear end of the inclined surface 446a and the inner surface of the rear wall 2c, but the terminal part may be disposed in other positions. In the above embodiment, four leg portions 26 protrude downwardly from the bottom surface of the holder 25, but the position and number of leg portions are not limited to those described above. In the above embodiment, the space SP1 where the holder 25 is disposed and the space SP3 where the electric component part 7 is disposed are defined into left and right sections through the vertical plate 45 as a second defining portion, but the second defining portion may define these spaces other than left and right. In the above embodiment, the holding apparatus 100 is installed in the premises of a house, but the holding apparatus to which the present invention is applied can be installed in various locations, not limited to the premises of a house. For example, the holding apparatus can be installed at a battery exchange station facing a road. In the above embodiment, the holding apparatus 100 is stationary, but the holding apparatus may be movable.

The above embodiment can be combined as desired with one or more of the above modifications. The modifications can also be combined with one another.

According to the present invention, the power storage device can be easily attached to or detached from the holder through the upper space of the housing.

Above, while the present invention has been described with reference to the preferred embodiments thereof, it will be understood, by those skilled in the art, that various changes and modifications may be made thereto without departing from the scope of the appended claims.

What is claimed is:

1. A holding apparatus comprising:
a holder holding a power storage device to be detachable; and
a housing provided to house the holder, wherein
the holder is provided such that an attachment and detachment direction in which the power storage device is attached to or detached from the holder is inclined with respect to a direction orthogonal to a placement surface of the housing.

2. The holding apparatus according to claim 1 further comprising:
a power conversion device provided to be capable of transmitting an electric power to and from the power storage device held by the holder; and
a defining portion defining a space, in which the holder and the power conversion device are disposed, in the housing.

3. The holding apparatus according to claim 2, wherein
the power conversion device is disposed below the holder, and
the defining portion is disposed below the holder and above the power conversion device.

4. The holding apparatus according to claim 3, wherein
the defining portion is provided to extend in a direction orthogonal to the attachment and detachment direction of the power storage device.

5. The holding apparatus according to claim 4, wherein
the defining portion is provided such that a lower end portion of the defining portion in an inclined direction orthogonal to the attachment and detachment direction of the power storage device is lower than a lower end portion of the holder in the inclined direction.

6. The holding apparatus according to claim 5, wherein
in the housing, a communicating hole communicating an inside and an outside of the housing is provided at a position below the lower end portion of the defining portion.

7. The holding apparatus according to claim 3, wherein
the defining portion includes a convex portion, which is provided to protrude upward from a surface on a side facing the holder.

8. The holding apparatus according to claim 7, wherein
the convex portion includes an inclined surface provided to be inclined with respect to a horizontal direction, and is disposed at a position corresponding to a communication hole communicating an inside and an outside of the holder.

9. The holding apparatus according to claim 8, wherein
the inclined surface is inclined in a downward gradient from an end portion to another end portion, and
a terminal portion is disposed, between the end portion of the inclined surface and an inner surface of the housing, to be electrically connected with the power storage device.

10. The holding apparatus according to claim 8, wherein
the holder includes a side wall provided on a downward side in a direction in which the inclined surface is inclined and a bottom wall facing to the inclined surface, and
the communication hole is provided in a corner portion where the side wall and the bottom wall intersect with each other.

11. The holding apparatus according to claim 7, wherein
the holder includes a leg portion provided to protrude downward from a surface on a side facing the defining portion, and
the leg portion is disposed at a position adjacent to the convex portion.

12. The holding apparatus according to claim 11, wherein
the leg portion includes two leg portions, and
the two leg portions are disposed on both sides of the convex portion.

13. The holding apparatus according to claim 3, wherein
the defining portion is a first defining portion, and
the holding apparatus according further comprising:
an electric component part electrically connected to the power conversion device; and
a second defining portion defining a space to dispose the holder and electric component part above the first defining portion in the housing.

14. The holding apparatus according to claim 1, wherein
the housing includes a case housing the holder, and a lid portion provided to be openable and closable with respect to the case and covering an insertion and removal port for inserting and removing the power storage device of the holder, and the lid portion includes, on a surface on a side facing the case in a closed state, a recessed portion recessed to avoid the power storage device held by the holder.

15. The holding apparatus according to claim 14, wherein
the lid portion includes, on a surface on an opposite side to the case in the closed state, a curved surface portion.

16. The holding apparatus according to claim 15, wherein
the curved surface portion is provided to be inclined with respect to a horizontal direction.

17. The holding apparatus according to claim 14, wherein
an opening is provided at an end portion on a side facing the lid portion in the case, and
in the holding apparatus, a communication hole is provided at a position corresponding to the insertion and removal port, and
the holding apparatus further comprising a closing portion closing the opening.

18. The holding apparatus according to claim 17 further comprising a coupling portion coupling the lid portion with the case so as to be openable and closable, wherein
one side of the coupling portion is fixed to a surface of the lid portion on a side facing the case, and another side of the coupling portion is fixed to a surface of the case on a side facing the lid portion, and
the closing portion includes a recessed portion provided to avoid the coupling portion.
